(19) United States
(12) Patent Application Publication
(10) Pub. No.: US 2024/0296486 A1
(43) Pub. Date: Sep. 5, 2024

(54) SYSTEMS AND METHODS ASSOCIATED WITH TRANSACTIONS INVOLVING ELECTRIC TRAILERS

(71) Applicant: Ford Global Technologies, LLC, Dearborn, MI (US)

(72) Inventor: Mahmoud Yousef Ghannam, Canton, MI (US)

(73) Assignee: Ford Global Technologies, LLC, Dearborn, MI (US)

(21) Appl. No.: 18/177,031

(22) Filed: Mar. 1, 2023

(51) Int. Cl. G06Q 30/0601; G06Q 30/0645

(52) U.S. Cl. CPC G06Q 30/0601; G06Q 30/0645

(57) ABSTRACT

The disclosure is generally directed to systems and methods associated with transactions involving electric trailers. An example method executed by a processor of an electric trailer administrative system in a vehicle can include evaluating a distributed ledger for obtaining information about one or more electric trailers, identifying an electric trailer that is compatible with the vehicle, and storing, in the distributed ledger, information pertaining to a transaction associated with the electric trailer. In an example scenario, the transaction is a rental request and the method further includes determining, based on evaluating the content of the distributed ledger, a charge level of a battery in the electric trailer, determining that the charge level of the battery is equal to, or greater than, a threshold charge level, and storing, in the distributed ledger, the first rental request based on the charge level being equal to, or greater than the threshold charge level.

### BACKGROUND

With the advent of online shopping, customers typically expect quick and easy access to information about various products and services and also expect transactions associated with such products and services to be convenient and easy to carry out. For example, a customer seeking to rent, lease, or purchase a vehicle expects quick and easy access to information about the vehicle and ease of carrying out actions associated with renting, leasing, or purchasing the vehicle.

However, access to information related to auxiliary items associated with a vehicle such as, for example, a trailer or a camper may, in some cases, be difficult to obtain, particularly, information pertaining to a compatibility of such an item with a personal vehicle that a customer may desire to use for towing the trailer or camper. It is therefore desirable to address this issue.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 shows an example system configured to facilitate transactions involving electric trailers in accordance with an embodiment of the disclosure.

FIG. 2 shows some example components that may be included in an electric trailer that is configured to perform transactions in accordance with an embodiment of the disclosure.

FIG. 3 shows some example components that may be included in a vehicle that is configured to perform transactions in accordance with an embodiment of the disclosure.

FIG. 4 shows an example scenario associated with the system illustrated in FIG. 1.

FIG. 5A, 5B show a flowchart of a method to execute a transaction that is associated with an electric trailer in accordance with an embodiment of the disclosure.

### DETAILED DESCRIPTION

### Overview

In terms of a general overview, embodiments described in this disclosure are generally directed to systems and methods associated with transactions involving electric trailers such as, for example, renting, leasing, or purchasing an electric trailer that is compatible with a vehicle of a customer. An example method executed by a processor of an electric trailer administrative system in a vehicle can include evaluating a distributed ledger for obtaining information about one or more electric trailers, identifying, based on evaluating a content of the distributed ledger, an electric trailer that is compatible with the vehicle, and storing, in the distributed ledger, information pertaining to a transaction associated with the electric trailer. In an example scenario, the transaction is a rental request and the method may further include determining, based on evaluating the content of the distributed ledger, a charge level of a battery in the electric trailer, determining that the charge level of the battery is equal to, or greater than, a threshold charge level, and storing, in the distributed ledger, the rental request based on determining that the charge level of the battery in the electric trailer is equal to, or greater than the threshold charge level. In an example scenario, the threshold charge level may be set on the basis of an expected usage of the battery during a trip. In one embodiment, the distributed ledger may be implemented as a blockchain where information is added to the blockchain as transactions, accessible by all confirmed parties (e.g., fleet/rental manager, driver/customer, etc.).

### Illustrative Embodiments

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and phrases are used herein solely for convenience and such words and terms should be interpreted as referring to various objects and actions that are generally understood in various forms and equivalencies by persons of ordinary skill in the art. For example, it must be understood that the word “database” as used herein can be replaced by various other words conveying an equivalent meaning such as, for example, “memory,” “register,” and “storage” without detracting from the context in which the word “database” is used herein. The word “compatible” as used herein can be replaced by various other words conveying an equivalent meaning such as, for example, “suitable” and “desirable.” The phrase “distributed ledger” as used herein can be replaced by various other phrases conveying an equivalent meaning such as, for example, “shared register” or “distributed memory.” The word “information” as used herein can be replaced by various other words conveying an equivalent meaning such as, for example, “data” and “content.” The word “information” as used herein content captured by use of various types of cameras and sensors provided in a vehicle (infrared sensors, motion detectors, sonar, radar, images, etc.). Words such as “element” “items,” or “objects” can refer to a vehicle or an electric trailer in the context of the description provided in the disclosure. It must also be understood that words such as “implementation,” “application,” “scenario,” “case,” and “situation” as used herein are an abbreviated version of the phrase “In an example (“implementation,” “application,” “scenario,” “case,” “approach,” and “situation”) in accordance with the disclosure.” Furthermore, the word “example” as used herein is intended to be non-exclusionary and non-limiting in nature.

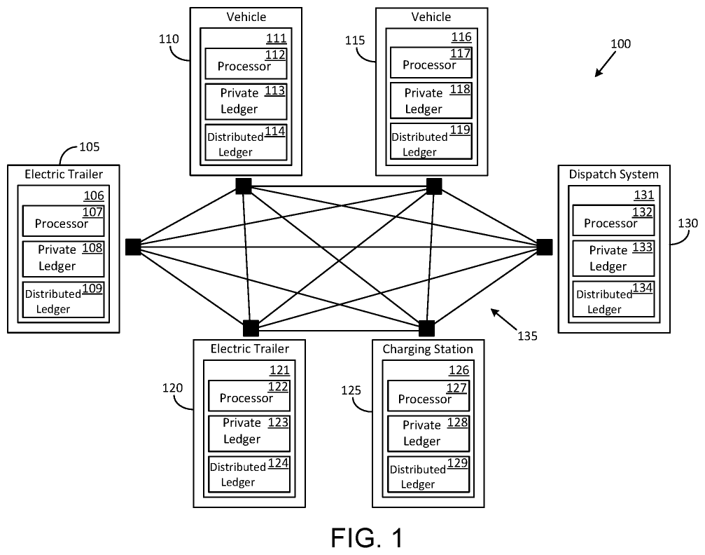

FIG. 1 shows an example system 100 configured to facilitate transactions involving electric trailers in accordance with an embodiment of the disclosure. The example system 100 illustrates a vehicle 110, a vehicle 115, a charging station 125, and a dispatch system 130. In other example system configurations, the number of vehicles, electric trailers, charging stations, and dispatch systems can be different or may be omitted (for example, the dispatch system 130 may be omitted in some cases). Each of the vehicle 110 and the vehicle 115 can be any of various types of vehicles configured for towing an electric trailer such as, for example, a sedan, a truck, a sports utility vehicle, a minivan, a bus, a semi (tractor portion), a gasoline-operated vehicle, a hybrid vehicle, or an electric vehicle. More particularly, each of the vehicle 110 and the vehicle 115 has a towing capacity that is adapted to tow one or more respective type of electric trailer. For example, the vehicle 110 may be a gasoline-operated truck having a towing capacity of 12,000 pounds and each of the electric trailer 105 and the electric trailer 120 can be weight-wise suitable to be towed by the vehicle 110. In another example, the vehicle 110 may be an electric truck having a towing capacity of 7,500 pounds and the electric trailer 105 may be too heavy to be towed by the vehicle 110. However, in this example, the electric trailer 120 may be weight-wise suitable to be towed by the vehicle 110.

Each of the vehicle 110 and the vehicle 115 may be equipped for towing an electric trailer in various other ways. For example, each of the vehicle 110 and the vehicle 115 may include hitching equipment (sway control bar, mounting ball, hitching pin, etc.) that can be used to mechanically couple the vehicle 110 or the vehicle 115 to an electrical trailer, and to provide an electrical interface (brake light signals, control signals, communication signals, etc.) between the vehicle 110 or the vehicle 115 and the electrical trailer.

The description henceforth will refer to the vehicle 110 and the electric trailer 105 as example items for purposes of convenience but it must be understood that the description is equally applicable to any other towing vehicle and electric trailer in accordance with the disclosure.

The electric trailer 105 can include a battery system (one or more batteries) and one or more electric motors that are powered by the battery system. Each of the electric motors is coupled to a wheel of the electric trailer 105 for providing propulsive power to move the electric trailer 105 forwards and/or backwards, independent of the vehicle 110 (towing vehicle). Thus, for example, the electric trailer 105 may be moved from one location to another without being coupled to the vehicle 110. When coupled to the vehicle 110, the propulsion system (battery, electric motor, transmission system, braking system, etc.) of the electric trailer 105 can cooperate with a propulsion system of the vehicle 110 in order to assist the propulsion system of the vehicle 110.

For example, when negotiating a steep hill, a processor 112 of an electric trailer administrative system 111 of the vehicle 110 may convey a signal to a processor 107 of an electric trailer administrative system 106 of the electric trailer 105 to activate one or more electric motors in the electric trailer 105 in order to assist a gasoline engine or an electric motor of the vehicle 110 negotiate the steep hill. In an example implementation, the signal may be conveyed through a hitch that couples the electric trailer 105 to the vehicle 110. In another example implementation, the signal may be conveyed via a wireless signal in any of various formats such as, for example, Bluetooth®, Ultra-Wideband, Wi-Fi, or Zigbee.

In accordance with the disclosure, it may be beneficial to have information about the propulsion system (battery, electric motor, transmission system, braking system, etc.) of the electric trailer 105 in order to make a determination whether the electric trailer 105 is compatible for attachment to the vehicle 110. In some cases, the propulsion system of the electric trailer 105 (battery, electric motor, etc.) may be incompatible with the vehicle 110. For example, a battery capacity and/or a charge level of a battery in the electric trailer 105 may be inadequate for use with the vehicle 110. Having information about a compatibility (or an incompatibility) of the electric trailer 105 in accordance with the disclosure, further permits a decision to be made regarding selecting the electric trailer 105 and executing a transaction in accordance with the disclosure. A few example transactions can include renting, leasing, or purchasing of the electric trailer 105.

Such types of information pertaining to the electric trailer 105 may be stored in one more databases of the system 100. In an example implementation, the system 100 includes a distributed ledger that is distributed across various components of the system 100. The example distributed ledger includes a distributed ledger 114 in the vehicle 110, a distributed ledger 119 in the vehicle 115, a distributed ledger 109 in the electric trailer 105, a distributed ledger 124 in the electric trailer 120, a distributed ledger 129 in the charging station 125, and a distributed ledger 134 in the dispatch system 130.

The distributed ledger contains information that can be read by any of the electric trailer administrative systems provided in the various elements. For example, the electric trailer administrative system 111 of the vehicle 110 can read the contents of the distributed ledger 119 of the vehicle 115, the distributed ledger 109 of the electric trailer 105, the distributed ledger 124 of the electric trailer 120, the distributed ledger 129 of the charging station 125, and/or the distributed ledger 134 of the dispatch system 130. Any element can enter information into the distributed ledger that is then made accessible to all other elements of the system 100. For example, the processor 112 of the electric trailer administrative system 111 of the vehicle 110 may enter into the distributed ledger 114, various types of information in accordance with the disclosure. The information may include, for example, details pertaining to a transaction conducted between the electric trailer administrative system 111 of the vehicle 110 with the electric trailer administrative system 106 in the electric trailer 105. In an example scenario, the transaction can be associated with a rental arrangement for renting the electric trailer 105.

The information entered into the distributed ledger 114 by the electric trailer administrative system 111 of the vehicle 110 is then broadcast into a peer-to-peer network 135 of the system 100. Each electric trailer administrative system of the various elements (the electric trailer administrative system 116 of the vehicle 115, the electric trailer administrative system 106 of the electric trailer 105, the electric trailer administrative system 121 of the electric trailer 120, the electric trailer administrative system 126 of the charging station 125, and the electric trailer administrative system 131 of the dispatch system 130) evaluates the information received through the peer-to-peer network 135. The evaluation may be carried out by use of any of various types of algorithms in order to collectively reach a consensus pertaining to the information (accuracy, timeliness, revision history, etc.). Once a consensus is achieved, all the distributed ledgers of the system 100 are updated to reflect the information that was entered into the distributed ledger 114 by the processor 112 of the electric trailer administrative system 111 in the vehicle 110.

In an example embodiment, the distributed ledgers of the system 100 use blockchain techniques to ensure trust and security of the information stored in various individual ledgers (the distributed ledger 114, distributed ledger 109, distributed ledger 124, distributed ledger 129, distributed ledger 134, etc.). More particularly with reference to the example system 100, each of the processor 107 of the electric trailer 105, the processor 122 of the electric trailer 120, the processor 112 of the vehicle 110, the processor 117 of the vehicle 115, the processor 127 of the charging station 125, and the processor 132 of the dispatch system 130, store information in the distributed ledger of the peer-to-peer network 135 in accordance with a majority consensus requirement. The decentralized configuration of the peer-to-peer network 135 and the use of blockchain technology offers several benefits over a centralized network where a single entity, such as, for example, a cloud server computer is used for storing and accessing data. The system 100 that includes the peer-to-peer network 135 further provides increased system reliability, privacy, scalability, and avoidance of a single point malfunction.

The types of information stored in the distributed ledger can vary in accordance with a nature of an application. For example, in an example application directed at transactions involving electric trailers (renting, leasing, purchase, etc.), the information stored by the vehicle 110 in the distributed ledger can include, for example, details pertaining to a pending leasing arrangement of the electric trailer 105. Information stored by the electric trailer 105 in the distributed ledger can include, for example, details pertaining to the pending leasing arrangement of the electric trailer 105 by the vehicle 110, ownership information related to the electric trailer 105, and the condition of various components of the electric trailer 105.

The information about the condition of various components of the electric trailer 105 can include, for example, information related to a battery (battery health, charge level, date of manufacture, charge capacity, power rating, etc.), information related to a weight of the electric trailer 105, hitch-related information (type of hitch, electrical connectivity, etc.), location information of the electric trailer 105, past usage/rental/leasing history of the electric trailer 105, financial information (rental rates, leasing rates, leasing conditions, contract documents, etc.), manufacture date of the electric trailer 105, condition of tires (mileage), and details of electric motors (drive capacity, mechanical condition, type of electric motor, date of manufacture of the electric motor, etc.).

Information stored by the charging station 125 in the distributed ledger (via the distributed ledger 129) can include, for example, location information of the charging station 125, charging capacity of the charging station, type of charger, financial information (fees), and availability.

Information stored by an electric trailer administrative system 131 of the dispatch system 130 in the distributed ledger (via the distributed ledger 134) can include, for example, a rental agreement between a first party and a second party in connection with the electric trailer 105 and/or the electric trailer 120, and an availability status of one or more electric trailers for sale, lease, or rental. The dispatch system 130 can be a computer, for example, that is used by a rental agency (U-Haul®, for example), a dealership (for sales), a leasing agency, or a private individual.

The system 100 further illustrates a private ledger that may be provided in each of the various components of the system 100 such as, for example, a private ledger 113 provided in the vehicle 110, a private ledger 118 provided in the vehicle 115, a private ledger 108 provided in the electric trailer 105, a private ledger 123 provided in the electric trailer 120, a private ledger 128 in the charging station 125, and a private ledger 133 provided in the dispatch system 130. Each private ledger is configured for storing information that is associated with an individual party and is inaccessible to other parties. For example, the private ledger 113 may be used by the processor 112 of the electric trailer administrative system 111 in the vehicle 110 to store information that is exclusive and private to the vehicle 110. This information is not intended for viewing by other parties such as, for example, the dispatch system 130 or the electric trailer 105. The private information may include, for example, financial information associated with the vehicle 110, a private contract arrangement between an owner of the vehicle 110 and an owner of the electric trailer 105, details pertaining to the vehicle 110 (make, model, towing capacity, dates, current condition, repair history, etc.). The private ledger 113 and other such private ledgers referred to herein, may be referred to as a wallet such as, for example, when the private ledger 113 is used to store financial information.

In an example implementation, the private ledger 113 may be configured to be physically isolated from the peer-to-peer network 135. In another example implementation, the private ledger 113 may be configured to be exclusively accessible to the processor 112. In yet another example implementation, the private ledger 113 may be password protected so as to render the contents of the private ledger 113 exclusively accessible to authorized individuals who know the password.

It must be understood that the peer-to-peer network 135 is merely one example network that may be used in accordance with the disclosure. Other types of networks such as, for example, a mesh network or a star network may be used in other implementations. In at least some implementations, the network 135 can include any one, or a combination of networks, such as, for example, a local area network (LAN), a wide area network (WAN), a telephone network, a cellular network, a cable network, a wireless network, and/or private/public networks such as the Internet.

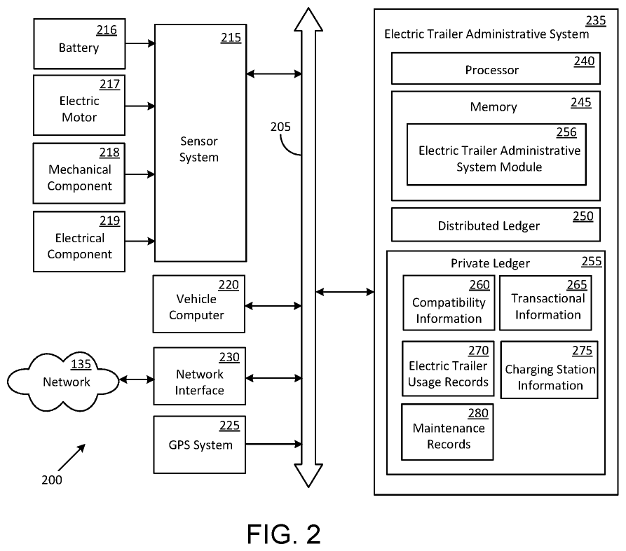

FIG. 2 shows some example components that may be included in an electric trailer 200 that is configured to perform transactions in accordance with an embodiment of the disclosure. The illustrated electric trailer 200 can be, for example, the electric trailer 105 or the electric trailer 120 illustrated in FIG. 1. The example components provided in the electric trailer 200 can include an electric trailer administrative system 235, a sensor system 215, a vehicle computer 220, a network interface 230, and a global positioning system (GPS) system 225.

The various components are communicatively coupled to each other via one or more buses such as, for example, a bus 205. The bus 205 may be implemented using various wired and/or wireless technologies. For example, the bus 205 can be a vehicle bus that uses a controller area network (CAN) bus protocol, a Media Oriented Systems Transport (MOST) bus protocol, and/or a CAN flexible data (CAN-FD) bus protocol. Some or all portions of the bus 205 may also be implemented using wireless technologies such as Bluetooth®, Ultra-Wideband, Wi-Fi, Zigbee®, or near-field-communications (NFC).

The sensor system 215 can include various types of sensors that are configured to obtain various types of information from various components of the electric trailer 200. In an example implementation, the sensor system 215 includes sensors configured to obtain information from a battery 216, an electric motor 217, a mechanical component 218, and an electrical component 219. It must be understood that the battery 216, the electric motor 217, the mechanical component 218, and the electrical component 219 are example components and in various implementations, the sensor system 215 can include sensors configured to obtain information from more than one battery, electric motor, mechanical component, and/or electrical component.

More particularly, the sensor system 215 can include a battery-monitoring sensor such as, for example, a charge level detector, that provides information to the sensor system 215 about the battery 216. The battery 216 provides power to the electric motor 217 that is coupled to a wheel of the electric trailer 200.

The sensor system 215 can further include one or more detectors such as, for example, a current measuring device and/or a voltage detector, that provides information to the sensor system 215 about the electric motor 217 and the electrical component 219. An example electrical component 219 can be a battery charging system (not shown) that may be used for charging the battery 216 at a charging station.

The sensor system 215 can further include one or more detectors such as, for example, a weight sensor, a camera, a pressure transducer, and/or an infrared motion detector, that provides information to the sensor system 215 about the mechanical component 218. An example mechanical component 218 can be a hitch (not shown) that may be used for attaching the electric trailer 200 to a towing vehicle.

The network interface 230 provides connectivity between the electric trailer administrative system 235 and various objects that may be communicatively coupled to the network 135 such as the example objects shown in FIG. 1 (electric trailer 105, vehicle 110, etc.).

The GPS system 225 is configured to provide to the electric trailer administrative system 235, information such as location information of the electric trailer 200, map information for a proposed travel route when hitched to a towing vehicle, and location information of one or more charging stations that may be used for charging the battery 216 in the electric trailer 200.

The vehicle computer 220 may provide to the electric trailer administrative system 235 various types of information related to the electric trailer 200 and may also perform some operations in response to signals received from the electric trailer administrative system 235. An example operation may involve operating the electric motor 217 for assisting a towing vehicle when negotiating a steep incline.

The electric trailer administrative system 235 can include a processor 240, a memory 245, a distributed ledger 250, and a private ledger 255. The memory 245, which is one example of a non-transitory computer-readable medium, may be used to store an operating system (not shown) and various code modules such as an electric trailer administrative system module 256. The code modules are provided in the form of computer-executable instructions that can be executed by the processor 240 for performing various operations in accordance with the disclosure.

The distributed ledger 250 can be, for example, the distributed ledger 109 described above with reference to the electric trailer 105. The private ledger 255 can be, for example, the private ledger 108 described above with reference to the electric trailer 105. More particularly, in this example, the private ledger 255 includes various types of information such as compatibility information 260, transactional information 265, electric trailer usage records 270, charging station information 275, and maintenance records 280.

Compatibility information 260 may include, for example, details about the electric trailer 200 that may be used to determine a compatibility between the electric trailer 200 and various types of towing vehicle. For example, the compatibility information 260 may include a weight of the electric trailer 200 that may be used to determine if a towing vehicle has a capacity to tow the electric trailer 200.

Transactional information 265 can include information that may be used for executing various transactions in accordance with the disclosure such as, for example, to rent, lease, or purchase the electric trailer 200. Such information may include financial information and information pertaining to documents such as contracts, agreements, and/or terms of use.

Electric trailer usage records 270 can include information such as, for example, mileage information, length of time used (number of days, weeks, etc.) and some details of customers who have used the electric trailer 200 (individuals, companies, rental agencies, etc.).

Charging station information 275 may include information about one or more charging stations located close to where the electric trailer 200 is located, type of charger that is compatible with the electric trailer 200, and contracted charging fees (if applicable).

Maintenance records 280 may include information about repairs and maintenance performed upon the electric trailer 200 over a period of time (years, for example).

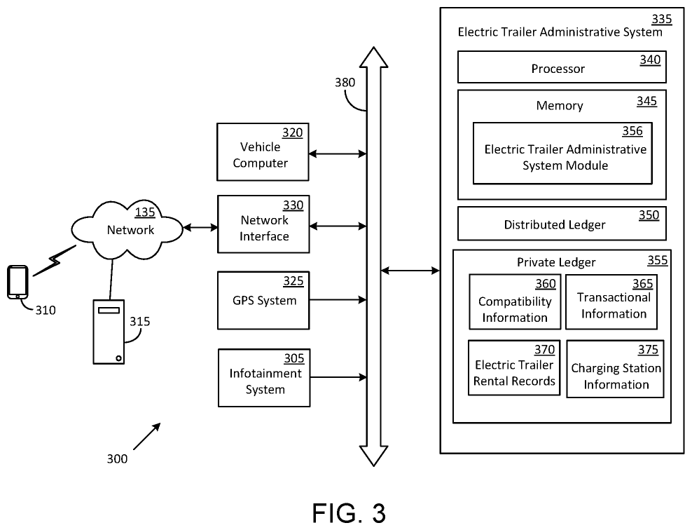

FIG. 3 shows some example components that may be included in a vehicle 300 that is configured to perform transactions in accordance with an embodiment of the disclosure. The illustrated vehicle 300 can be, for example, the vehicle 110 or the vehicle 115 illustrated in FIG. 1. The example components provided in the vehicle 300 can include an electric trailer administrative system 335, a vehicle computer 320, a network interface 330, a global positioning system (GPS) system 325, and an infotainment system 305. At least some of these components can be similar to, or identical, to the components described above with reference to the electric trailer 200 illustrated in FIG. 2. The various components are communicatively coupled to each other via one or more buses such as, for example, a bus 380 that may be similar or identical to the bus 205 described above.

The vehicle computer 320 executes various operations associated with the vehicle 300. In an example scenario, where the vehicle 300 is a gasoline-operated vehicle, the vehicle computer 320 may perform various operations associated with the vehicle 300, such as controlling engine operations (fuel injection, speed control, emissions control, braking, etc.), managing climate controls (air conditioning, heating etc.), activating airbags, and issuing alerts (check engine light, bulb defect, low tire pressure, etc.). In another example scenario, where the vehicle 300 is an electric vehicle, the vehicle computer 320 may perform various operations associated with a battery system and one or more electric motors such as, coupling power into the electric motors for moving the vehicle, and charging operations associated with the battery, and monitoring operations associated with the battery and electric motors.

The vehicle computer 320 may be further configured to cooperate with the electric trailer administrative system 335 for performing various operations in accordance with the disclosure. An example operation may involve maneuvering the vehicle 300 for hitching the vehicle 300 to an electric trailer.

The network interface 330 provides connectivity between the electric trailer administrative system 335 and various devices that may be communicatively coupled to the network 135 described above. In an example implementation, a personal device 310 and/or a computer 315 may be communicatively coupled to the electric trailer administrative system 335 via the network 135. The personal device 310 can be, for example, a smartphone used by an individual such as, for example, a customer seeking to rent, lease, or purchase an electric trailer. The computer 315 can be, for example, a desktop personal computer, a laptop computer, or a tablet device that may be used by the customer.

The infotainment system 305 that is communicatively coupled to the electric trailer administrative system 335 via the bus 380 can include a display and a human-machine interface (HMI). The HMI (a touchscreen on the display, for example) may be used by a customer (driver of a vehicle, owner of a vehicle, family member of an owner of a vehicle, etc.) to submit a request to the electric trailer administrative system 335 for renting, leasing, or purchasing an electric trailer.

The GPS system 325 is configured to provide to the electric trailer administrative system 335, information such as, for example, location information of the vehicle 300, map information for a proposed travel route, navigation guidance, and location information of one or more charging stations that may be used for charging a battery in the vehicle 300 and a battery in an electric trailer that may be attached to the vehicle 300.

The electric trailer administrative system 335 can include a processor 340, a memory 345, a distributed ledger 350, and a private ledger 355. The memory 345, which is another example of a non-transitory computer-readable medium, may be used to store an operating system (not shown) and various code modules such as an electric trailer administrative system module 356. The code modules are provided in the form of computer-executable instructions that can be executed by the processor 340 for performing various operations in accordance with the disclosure. An example operation is described below by use of a flowchart 500.

The distributed ledger 350 can be, for example, the distributed ledger 114 described above with reference to the vehicle 110. The private ledger 355 can be, for example, the private ledger 113 described above with reference to the vehicle 110. More particularly, in this example, the private ledger 355 includes various types of information such as compatibility information 360, transactional information 365, electric trailer rental records 370, and charging station information 375.

Compatibility information 360 may include, for example, details about the vehicle 300 that may be used to determine a compatibility between the vehicle 300 and various types of electric trailers. For example, the compatibility information 360 may include a weight of the vehicle 300 that may be used by the processor 340 of the electric trailer administrative system 335 to determine if the vehicle 300 has a capacity to tow a particular type of electric trailer.

Transactional information 365 can include information that may be used by the processor 340 of the electric trailer administrative system 335 for executing various transactions in accordance with the disclosure such as, for example, to rent, lease, or purchase the electric trailer 200. Such information may include financial information and information associated with contracts, agreements, terms of use, etc.

Electric trailer rental records 370 can include information such as, for example, previous types of electric trailers that were rented for attaching to the vehicle 300 and the agencies from which the rentals were obtained.

Charging station information 375 may include information about one or more charging stations located close to where the vehicle 300 is located at any instant in time when the vehicle 300 is moving on a travel route, for example.

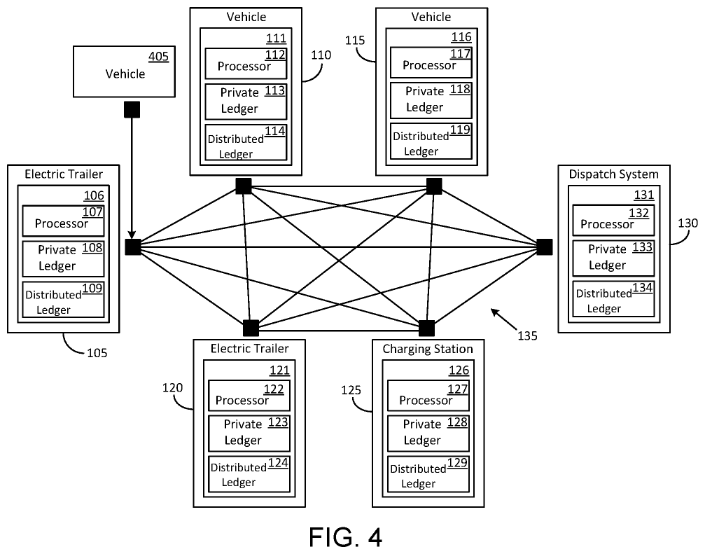

FIG. 4 shows an example scenario that may be associated with the system 100 illustrated in FIG. 1. The example scenario may occur as a result of execution of a method in accordance with the disclosure. The method, which may be executed by the processor 112 of the electric trailer administrative system 111 in the vehicle 110, can include evaluating the distributed ledger 114 for obtaining information about one or more electric trailers and identifying, based on evaluating a content of the distributed ledger 114, an electric trailer such as, for example, the electric trailer 105, that is compatible with the vehicle 110. Information pertaining to a transaction that may be carried out with respect to the electric trailer 105 may then be stored in the distributed ledger 114.

The transaction may, for example, be a rental request, and the method may further include determining, based on evaluating the content of the distributed ledger 114, a charge level of a battery (not shown) in the electric trailer 105. A determination may be made whether the charge level of the battery is equal to, or greater than, a threshold charge level. In an example implementation, the threshold charge level may be set on the basis of an expected level of usage of the battery during a planned trip by the vehicle 110. The rental request may be carried out if it is determined that the charge level of the battery in the electric trailer 105 is equal to, or greater than the threshold charge level.

A first type of information related to the rental request may then be stored in the private ledger 113 of the vehicle 110. The first type of information may be private in nature, such as, for example, financial information related to the rental request. Storing the first type of information in the private ledger 113 of the vehicle 110 prevents exposure of the information to various entities such as, for example, a competing entity. The private information may also be stored by the processor 107 in the private ledger of the electric trailer 105 for further action in the matter.

A second type of information related to the rental request may be stored in the distributed ledger 114 of the vehicle 110 and/or in the distributed ledger 109 of the electric trailer 105. The second type of information may be public in nature, such as, for example, reservation information of the electric trailer 105 for use by the vehicle 110 based on finalizing of the rental request. Storing the second type of information in the distributed ledger 114 and/or the distributed ledger 109, allows access to the information by any entity who is communicatively coupled to the peer-to-peer network 135 and authorized to access the distributed ledger 114 and/or the distributed ledger 109.

In the illustrated scenario, the electric trailer 105 receives a rental request from a vehicle 405 that may be unknown to the electric trailer 105. Upon receiving the rental request, the processor 107 of the electric trailer 105 examines the contents of the private ledger 108 and/or the distributed ledger 109, to identify the vehicle 405 and to respond to the rental request. The examination of the private ledger 108 and/or the distributed ledger 109 may indicate that the vehicle 405 is not authorized to make the rental request. Consequently, the processor 107 denies the rental request.

In another scenario, the processor 117 of the vehicle 115 may seek to rent the electric trailer 105. However, upon examining the distributed ledger 119, the processor 117 finds information that indicates that the electric trailer 105 has already been assigned to the vehicle 110 for rental. In this case, the processor 117 may carry out actions such as refraining from submitting a rental request to the electric trailer 105 or submitting a reservation request for use of the electric trailer 105 at a later time.

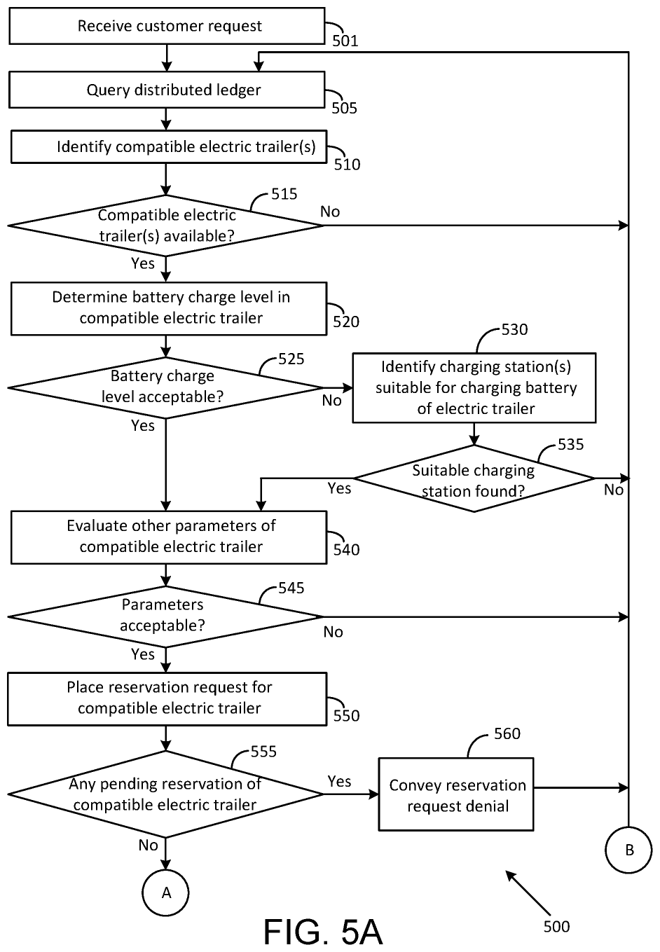

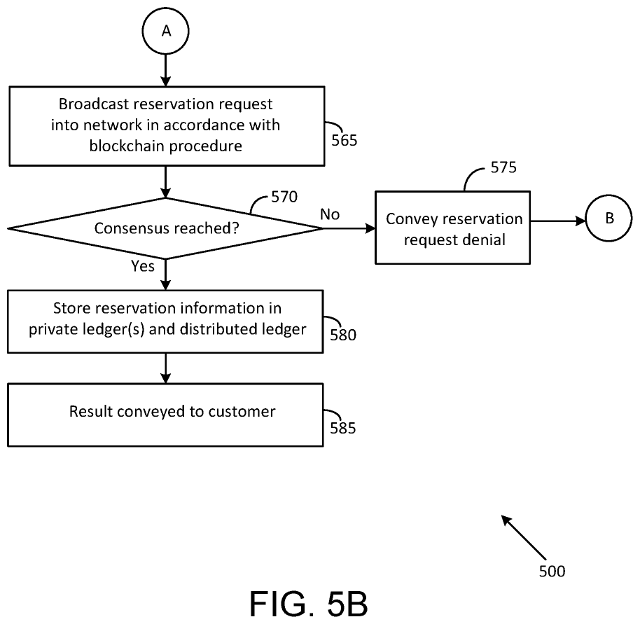

FIG. 5A, 5B show a flowchart 500 of a method to execute a transaction that is associated with an electric trailer in accordance with an embodiment of the disclosure. The flowchart 500 illustrates a sequence of operations that can be implemented in hardware, software, or a combination thereof. In the context of software, the operations represent computer-executable instructions stored on one or more non-transitory computer-readable media such as the memory 345 shown in FIG. 3, that, when executed by one or more processors such as the processor 340 shown in FIG. 3, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be carried out in a different order, omitted, combined in any order, and/or carried out in parallel. In an example embodiment, the various operations shown in the flowchart 500 are performed by one or more processors without human intervention.

At block 501, a request is received by a processor of an electric trailer administrative system of a vehicle. The request may be originated by a customer seeking to rent, lease, or purchase an electric trailer. In an example scenario, the customer may provide the request by use of a personal device (a smartphone, for example), a computer (a desktop computer or a laptop computer, for example), or an infotainment system of the vehicle. The customer desires to automate the process of renting, leasing, or purchasing an electric trailer as a replacement of a laborious manual process that can involve searching for various sources of information, determining a compatibility of one or more electric trailers for use with his/her vehicle, and executing various business and/or financial actions associated with renting, leasing, or purchasing an electric trailer. The manual process can be inefficient and sub-optimal in several ways such as, for example, dependent on the skills of the customer to perform the tasks, the type of information available to the customer for evaluation, and accessibility to the information.

At block 505, the processor queries a distributed ledger for obtaining information related to electric trailers. In an example embodiment, the distributed ledger is located in the electric trailer administrative system of the vehicle and contains information that can be updated, revised, and contributed to, by a number of information sources who are participants of the distributed ledger. Storing and updating of information in the distributed ledger(s) may be carried out in various ways so as to provide security and ensure trust. In an example implementation, the storing and updating of such information is carried out by using blockchain operations. In another example embodiment, the distributed ledger is located in a cloud computer or a server computer. Security measures may be provided in the cloud computer and/or the server computer to ensure trust.

At block 510, one or more electric trailers that are compatible for use with the vehicle is identified based on evaluating data stored in the distributed ledger. In an example implementation, the compatibility may be determined on the basis of a weight of an electric trailer and a towing capacity of the vehicle.

At block 515, the distributed ledger may be examined to determine an availability of an electric trailer that has been found compatible for use with the vehicle. The availability information may be stored in the distributed ledger based on information provided by one or more electric trailers having processors that are communicatively coupled to each other via a peer-to-peer network.

If, at block 515, no compatible electric trailer is available, the operations indicated in block 505, block 510, and block 515 may be repeated, for example, at a later time.

If, at block 515, a compatible trailer is found available, at block 520 a charge level of a battery in the electric trailer is determined. Information pertaining to the charge level of the battery may be provided by the compatible electric trailer in response to a query originated by the processor in the vehicle and conveyed to a processor in the electric trailer via the network. The battery level may be determined based on the use of one or more sensors provided in the compatible electric trailer.

At block 525, a determination is made whether the charge level of the battery is acceptable for use by the vehicle. In an example scenario, the determination may be made by comparing the charge level of the battery to a threshold charge level. The threshold charge level may be set, for example, on the basis of an expected level of usage of the battery during a planned trip by the vehicle. In one case, a travel route of the planned trip may extend over a first distance and over flat terrain. The battery consumption may be low due to relatively low activation of an electric motor in the electric trailer. In this case, the threshold charge level is set to a first level that is smaller than a second threshold charge level that may be applicable when the planned trip extends over a second distance that is greater than the first distance and over hilly terrain (or when a laden weight of the vehicle 110 is high). The battery consumption may be high as a result of relatively high number of activations of the electric motor in the electric trailer.

If, at block 525, it is determined that the charge level of the battery is unacceptable for use by the vehicle (such as, for example, when the charge level is lower than a threshold charge level), at block 530, a charging station may be identified for charging the battery.

At block 535, a determination is made whether the charging station is suitable for use to charge the battery. In an example scenario, the determination may be made on the basis of the charging station being located within a threshold distance of the electric trailer (two miles, for example). In another example scenario, the determination may be made on the basis of a charging fee at the charging station being less than a threshold amount.

If, at block 535, the charging station is found unsuitable for use, in an example sequence (not illustrated), the operations indicated at block 530 and block 535 may be executed sequentially in a recursive manner until a suitable charging station is identified.

If no suitable charging station is identified, the operations indicated at block 505 and subsequent blocks may be executed.

If a suitable charging station is identified, at block 540, one or more other attributes of the compatible electric trailer is evaluated. For example, hitching equipment of the electric trailer, size of the electrical trailer, and facilities provided in the electric trailer (for example, appliances, kitchen facilities, bed, etc.) may be evaluated. Such information may be made available by a processor in the electric trailer storing the information in a distributed ledger of the electric trailer.

At block 545, a determination is made whether the attributes of the compatible electric trailer are acceptable. If found unacceptable, the operations indicated at block 505 and subsequent blocks may be executed.

If found acceptable, at block 550, a reservation request for the compatible electric trailer is placed. The request may be communicated by the processor in the vehicle to the processor in the electric trailer via a network.

At block 555, the processor in the electric trailer evaluates a private ledger of the electric trailer to determine whether a pending reservation is present for the compatible electric trailer in the private ledger.

If a pending reservation exists, at block 560, the processor in the electric trailer conveys to the vehicle, via the network, a denial of the reservation request. The processor in the vehicle may perform the operations indicated at block 505 and subsequent blocks upon receiving the denial.

If no pending reservation exists, at block 565, the processor in the electric trailer broadcasts the reservation request into the peer-to-peer network by using a blockchain procedure.

At block 570, a determination is made by the processor in the electric trailer whether a consensus has been reached with respect to the reservation request in accordance with the blockchain format.

If, at block 570, a consensus is not achieved, at block 575, the processor in the electric trailer conveys to the vehicle, via the network, a denial of the reservation request. The processor in the vehicle may perform the operations indicated at block 505 and subsequent blocks upon receiving the denial.

If, at block 570, a consensus is achieved, at block 580, the processor in the electric trailer stores private information pertaining to the reservation in a private ledger of the vehicle trailer and in public information in the distributed ledger of the vehicle trailer. The private information pertaining to the reservation may also be stored by the processor in the vehicle in a private ledger of the vehicle.

At block 585, the results of the automated procedure that was executed via the operations described above may be conveyed to the customer. In an example embodiment, the results may be displayed on the personal device, the computer, and/or the infotainment system that was used by the customer for making the request as indicated at block 501. In some cases, the customer may examine the displayed results and provide an approval for proceeding with finalizing the renting, leasing, or purchasing of the electric trailer.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, cause the processor to perform a certain function or group of functions. The computer-executable instructions may be, for example, binaries, intermediate format instructions, such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device, such as the various databases described above, can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
evaluating, by a first processor of a first vehicle, a distributed ledger, for obtaining information about one or more electric trailers;
identifying, by the first processor, based on evaluating a content of the distributed ledger, a first electric trailer that is compatible with the first vehicle; and
storing, by the first processor, in the distributed ledger, based on a blockchain operation, information pertaining to a transaction associated with the first electric trailer.

2. The method of claim 1, wherein the transaction comprises a first rental request for the first electric trailer, and wherein the method further comprises:
determining, by the first processor, based on evaluating the content of the distributed ledger, a charge level of a battery in the first electric trailer;
determining, by the first processor, that the charge level of the battery is equal to, or greater than, a threshold charge level; and
storing, by the first processor, in the distributed ledger, the first rental request based on determining that the charge level of the battery in the first electric trailer is equal to, or greater than the threshold charge level.

3. The method of claim 1, wherein the transaction comprises one of a first rental request, a first lease request, or a first purchase request, and wherein the method further comprises:
entering, by the first processor, into a first private ledger, information pertaining to the one of the first rental request, the first lease request, or the first purchase request.

4. The method of claim 3, wherein the method further comprises:
entering, by a second processor of the first electric trailer, into a second private ledger of the first electric trailer, the information pertaining to the one of the first rental request, the first lease request, or the first purchase request; and
limiting, by the second processor, access to the second private ledger to a first electric trailer administrative systems that are other than a second electric trailer administrative system of the first electric trailer.

5. The method of claim 3, wherein the distributed ledger is accessible via a network and wherein the first private ledger is isolated from the network.

6. The method of claim 5, wherein the network is a peer-to-peer network configured to provide blockchain operations and wherein storing, by the first processor, in the distributed ledger, information pertaining to the one of the first rental request, the first lease request, or the first purchase request, is based on executing the blockchain operation in cooperation with at least one of a second electric trailer administrative system of the first electric trailer, a third electric trailer administrative system in a second vehicle, or a fourth electric trailer administrative system in a network administrative computer.

7. The method of claim 5, wherein the network is a peer-to-peer network configured to support blockchain operations and wherein the content of the distributed ledger is secured by use of blockchain operations to store the content in the distributed ledger.

8. A method comprising:
accessing, by a first processor, a distributed ledger, for obtaining information about one or more electric trailers;
identifying, by the first processor, based on evaluating a content of the distributed ledger, a first electric trailer that is compatible with a first vehicle;
determining, by the first processor, based on information stored in the distributed ledger, a charge level of a battery in the first electric trailer; and
executing, by the first processor, based on at least the charge level of the battery, a transaction involving the first electric trailer.

9. The method of claim 8, wherein the distributed ledger includes blockchain operations and wherein identifying the first electric trailer that is compatible with the first vehicle comprises at least one of comparing a weight of the first electric trailer to a towing capacity of the first vehicle and evaluating a drive capacity of one or more electric motors of the first electric trailer.

10. The method of claim 8, further comprising:
evaluating the charge level of the battery in view of at least one of a planned travel distance of the first vehicle, a laden weight of the first vehicle, or a characteristic of a terrain on a planned travel route of the first vehicle.

11. The method of claim 8, wherein the distributed ledger is coupled to a peer-to-peer network, wherein the first processor is a part of a first electric trailer administrative system provided in one of the first vehicle that is coupled to the distributed ledger via the peer-to-peer network or in a computer that is coupled to the distributed ledger via the peer-to-peer network, and wherein the transaction comprises one of a rental transaction, a lease transaction, or a purchase transaction involving the first electric trailer.

12. The method of claim 11, wherein the peer-to-peer network is configured to support blockchain operations and wherein the method further comprises:
storing, by the first processor, in the distributed ledger, information pertaining to the one of the rental transaction or the purchase transaction, the storing based on executing a blockchain operation in cooperation with at least a second electric trailer administrative system that is coupled to the peer-to-peer network.

13. The method of claim 8, further comprising:
determining, by the first processor, based on information stored in the distributed ledger, at least one of a location of the first electric trailer, ownership information of the first electric trailer, financial information associated with executing the transaction, or mechanical condition information of the first electric trailer; and
executing, by the first processor, the transaction involving the first electric trailer further based on the at least one of the location of the first electric trailer, the ownership information of the first electric trailer, the financial information associated with executing the transaction, or the mechanical condition information of the first electric trailer.

14. A system comprising:
a distributed ledger configured to store information associated with a plurality of electric trailers; and
a first electric trailer administrative system configured to interoperate with the distributed ledger for obtaining information about the plurality of electric trailers, the information including a charge level of a battery in at least one of the plurality of electric trailers.

15. The system of claim 14, wherein the distributed ledger is a coupled to a peer-to-peer network and is configured to support blockchain operations, wherein the first electric trailer administrative system is provided in a first vehicle, and wherein the first electric trailer administrative system is configured to store information in the distributed ledger by executing a blockchain operation.

16. The system of claim 15, wherein the information stored in the distributed ledger comprises at least one of a rental transaction, a lease transaction, or a purchase transaction involving the first vehicle and at least a first electric trailer among the plurality of electric trailers.

17. The system of claim 15, wherein the information stored in the distributed ledger comprises at least one of a weight of a first electric trailer, a drive capacity of one or more electric motors of the first electric trailer, or battery health information of a battery in the first electric trailer.

18. The system of claim 15, wherein the first electric trailer administrative system includes a first private ledger configured to at least store information about a first electric trailer that is included in the plurality of electric trailers and is compatible with the first vehicle.

19. The system of claim 18, further comprising:
a second vehicle that includes a second electric trailer administrative system configured to interoperate with the distributed ledger, the second electric trailer administrative system comprising a second private ledger configured to store information about a second electric trailer among the plurality of electric trailers that is associated with the second vehicle.

20. The system of claim 19, wherein the first private ledger is inaccessible to the second electric trailer administrative system and the second private ledger is inaccessible to the first electric trailer administrative system.
